(19) United States
(12) Patent Application Publication
(10) Pub. No.: US 2023/0078473 A1
(43) Pub. Date: Mar. 16, 2023

(54) SYSTEM AND METHOD FOR ROBUST NEURAL NETWORKING VIA NOISE INJECTION

(71) Applicants: Deliang Fan, Tempe, AZ (US); Adnan Siraj Rakin, Tempe, AZ (US); Li Yang, Tempe, AZ (US); Chaitali Chakrabarti, Tempe, AZ (US); Yu Cao, Gilbert, AZ (US); Jae-sun Seo, Tempe, AZ (US); Jingtao Li, Tempe, AZ (US)

(72) Inventors: Deliang Fan, Tempe, AZ (US); Adnan Siraj Rakin, Tempe, AZ (US); Li Yang, Tempe, AZ (US); Chaitali Chakrabarti, Tempe, AZ (US); Yu Cao, Gilbert, AZ (US); Jae-sun Seo, Tempe, AZ (US); Jingtao Li, Tempe, AZ (US)

(73) Assignee: Arizona Board of Regents on behalf of Arizona State University, Scottsdale, AZ (US)

(21) Appl. No.: 17/932,104

(22) Filed: Sep. 14, 2022

Related U.S. Application Data
(60) Provisional application No. 63/243,762, filed on Sep. 14, 2021.

(51) Int. Cl. G06N 3/08; G06N 3/04

(52) U.S. Cl. CPC G06N 3/08; G06N 3/0481

(57) ABSTRACT

A robust and accurate binary neural network, referred to as RA-BNN, is provided to simultaneously defend against adversarial noise injection and improve accuracy. Recently developed adversarial weight attack, a.k.a. bit-flip attack (BFA), has shown enormous success in compromising deep neural network (DNN) performance with an extremely small amount of model parameter perturbation. To defend against this threat, embodiments of RA-BNN adopt a complete binary neural network (BNN) to significantly improve DNN model robustness (defined as the number of bit-flips required to degrade the accuracy to as low as a random guess). To improve clean inference accuracy, a novel and efficient two-stage network growing method is proposed and referred to as early growth. Early growth selectively grows the channel size of each BNN layer based on channel-wise binary masks training with Gumbel-Sigmoid function. Apart from recovering the inference accuracy, the RA-BNN after growing also shows significantly higher resistance to BFA.

### CROSS-REFERENCE TO RELATED APPLICATIONS

This application claims priority to U.S. Provisional Application No. 63/243,762, filed Sep. 14, 2021, incorporated herein by reference in its entirety.

### FIELD OF THE DISCLOSURE

The present disclosure relates to deep neural networks (DNN), and in particular to protection of DNNs from adversarial attacks.

### BACKGROUND

Recently, deep neural networks (DNNs) have been deployed in many safety-critical applications. The security of DNN models has been widely scrutinized using adversarial input examples, where the adversary maliciously crafts and adds input noise to fool a DNN model. Recently, the vulnerability of model parameter (e.g., weight) perturbation has raised another dimension of security concern on the robustness of DNN model itself.

Adversarial weight attack can be defined as an attacker perturbing target DNN model parameters stored or executing in computing hardware to achieve malicious goals. Such perturbation of model parameters is feasible due to the development of advanced hardware fault injection techniques, such as row hammer attack, laser beam attack and under-voltage attack. Moreover, due to the development of side-channel attacks, it has been demonstrated that the complete DNN model information can be leaked during inference (e.g., model architecture, weights, and gradients). This allows an attacker to exploit a DNN inference machine (e.g., GPU, FPGA, mobile device) under an almost whitebox threat model. Inspired by the potential threats of fault injection and side-channel attacks, several adversarial DNN model parameter attack algorithms have been developed to study the model behavior under malicious weight perturbation.

### SUMMARY

A robust and accurate binary neural network, referred to as RA-BNN, is provided to simultaneously defend against adversarial noise injection and improve accuracy. Recently developed adversarial weight attack, also known as bit-flip attack (BFA), has shown enormous success in compromising deep neural network (DNN) performance with an extremely small amount of model parameter perturbation. To defend against this threat, embodiments of RA-BNN adopt a complete binary (i.e., for both weights and activation) neural network (BNN) to significantly improve DNN model robustness (defined as the number of bit-flips required to degrade the accuracy to as low as a random guess).

However, such an aggressive low bit-width model suffers from poor clean (i.e., no attack) inference accuracy. To counter this, a novel and efficient two-stage network growing method is proposed and referred to as early growth. Early growth selectively grows the channel size of each BNN layer based on channel-wise binary masks training with Gumbel-Sigmoid function. Apart from recovering the inference accuracy, the RA-BNN after growing also shows significantly higher resistance to BFA.

Evaluation on the CIFAR-10 dataset shows that the proposed RA-BNN can improve the clean model accuracy by ˜2-8%, compared with a baseline BNN, while simultaneously improving the resistance to BFA by more than 125×. Moreover, on the ImageNet dataset, with a sufficiently large (e.g., 5,000) amount of bit-flips, the baseline BNN accuracy drops to 4.3% from 51.9%, while the RA-BNN accuracy only drops to 37.1% from 60.9% (a 9% clean accuracy improvement).

An exemplary embodiment provides an RA-BNN. The RA-BNN includes a first DNN layer having a non-binary input and binarized weights; a last DNN layer having a non-binary input and binarized weights; and one or more intermediate DNN layers between the first DNN layer and the last DNN layer, wherein the one or more intermediate DNN layers have binary inputs and binarized weights.

Another exemplary embodiment provides a method for strengthening a BNN against adversarial noise injection. The method includes binarizing weights of each layer of the BNN; and binarizing inputs of each intermediate layer of the BNN between a first layer and a last layer such that an input of the first layer is not binarized.

Another exemplary embodiment provides a method for training a BNN using early growth. The method includes training and channel-wise growing the BNN from an initial BNN to a larger BNN; and retraining the larger BNN to minimize a defined loss.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a graphical representation of robustness of a Resnet-20 deep neural network (DNN) on Cifar10 dataset as a function of bit-width of weights and activation.

FIG. 2 is a graphical representation of clean accuracy of three binary models with channel multiplier varied as 1/2/3 and an 8-bit model.

FIG. 3 is a schematic diagram illustrating the early growth method according to embodiments described herein.

FIG. 4 is a schematic diagram illustrating binary mask training according to embodiments described herein through a combination of Gumbel-Sigmoid function and hard thresholding.

FIG. 5 is a graphical representation of a sample training of robust and accurate binary neural network (RA-BNN) where early growth increases the number of activating channels at each layer of a binary neural network (BNN).

FIG. 6A is a graphical representation of a layer-wise bit-flip profile of RA-BNN evaluated on ResNet-20.

FIG. 6B is a graphical representation of a layer-wise bit-flip profile of RA-BNN evaluated on ResNet-18.

FIG. 6C is a graphical representation of a layer-wise bit-flip profile of RA-BNN evaluated on VGG.

FIG. 7 is a flow diagram illustrating a process for strengthening a BNN against adversarial noise injection.

FIG. 8 is a flow diagram illustrating a process for training a BNN using early growth.

FIG. 9 is a block diagram of a computer system suitable for implementing the RA-BNN according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A robust and accurate binary neural network, referred to as RA-BNN, is provided to simultaneously defend against adversarial noise injection and improve accuracy. Recently developed adversarial weight attack, also known as bit-flip attack (BFA), has shown enormous success in compromising deep neural network (DNN) performance with an extremely small amount of model parameter perturbation. To defend against this threat, embodiments of RA-BNN adopt a complete binary (i.e., for both weights and activation) neural network (BNN) to significantly improve DNN model robustness (defined as the number of bit-flips required to degrade the accuracy to as low as a random guess).

However, such an aggressive low bit-width model suffers from poor clean (i.e., no attack) inference accuracy. To counter this, a novel and efficient two-stage network growing method is proposed and referred to as early growth. Early growth selectively grows the channel size of each BNN layer based on channel-wise binary masks training with Gumbel-Sigmoid function. Apart from recovering the inference accuracy, the RA-BNN after growing also shows significantly higher resistance to BFA.

Evaluation on the CIFAR-10 dataset shows that the proposed RA-BNN can improve the clean model accuracy by ˜2-8%, compared with a baseline BNN, while simultaneously improving the resistance to BFA by more than 125×. Moreover, on the ImageNet dataset, with a sufficiently large (e.g., 5,000) amount of bit-flips, the baseline BNN accuracy drops to 4.3% from 51.9%, while the RA-BNN accuracy only drops to 37.1% from 60.9% (a 9% clean accuracy improvement).

### I. Introduction

Among the popular adversarial weight attacks, bit-flip attack (BFA) is proven to be highly successful in hijacking DNN functionality (e.g., degrading accuracy as low as random guess) by flipping an extremely small amount (e.g., tens out of millions) of weight memory bits stored in computer main memory. In this context, robustness of a DNN is defined herein as the degree of DNN resistance against bit-flip attack, meaning a more robust network should require a greater number of bit-flips to hijack its function.

A series of defense works have attempted to mitigate such a potent threat. Among them, the binary weight neural network has proven to be the most successful one in defending against BFAs. For example, binarization of weight has been shown to improve model robustness by 4×-28×. Note that prior BFA defense work has not explored the impact of binary activation. However, for a binary weight neural network, with a sufficiently large amount of attack iterations, the attacker can still successfully degrade its accuracy to as low as random guess. More importantly, due to aggressively compressing the floating-point weights (i.e., 32 bits or more) into binary (1 bit), BNN inevitably sacrifices its clean model accuracy by 10-30%. Therefore, one goal of embodiments described herein is to construct a robust and accurate binary neural network (with both binary weight and activation) to simultaneously defend against BFAs and improve clean model accuracy.

To illustrate the motivation of this disclosure, the accuracy and robustness of a ResNet-20 network (as described in Kaiming He, Xiangyu Zhang, Shaoqing Ren, and Jian Sun, “Deep Residual Learning for Image Recognition,” in Proceedings of the IEEE Conference on Computer Vision and Pattern Recognition, pages 770-778, 2016) was tested with different bit-widths of weights and activation using CIFAR-10 dataset (as described in Alex Krizhevsky, Vinod Nair, and Geoffrey Hinton, Cifar-10 (canadian institute for advanced research), URL http://www.cs.toronto.edu/kriz/cifar.html, 2010), following the same BFA methods in prior works.

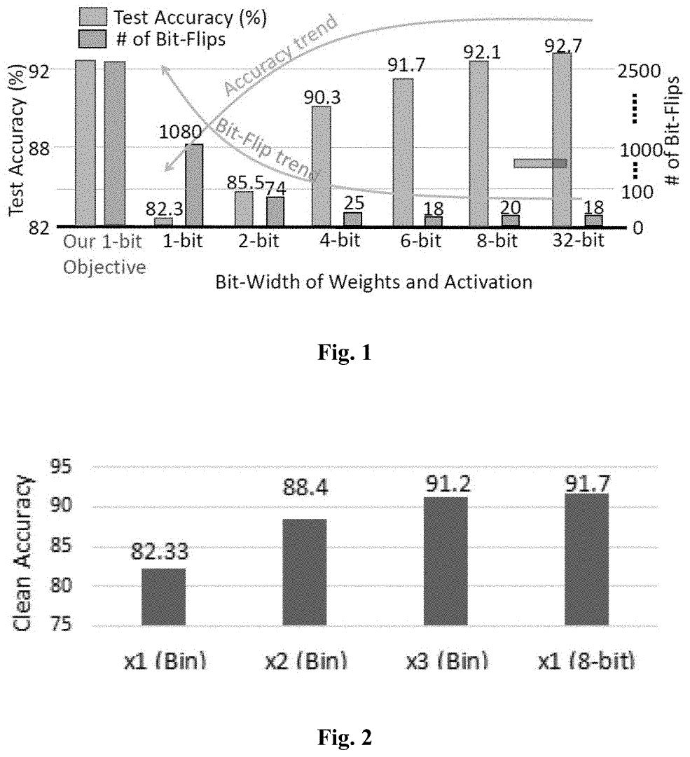

FIG. 1 is a graphical representation of robustness of the Resnet-20 DNN on Cifar10 dataset as a function of bit-width of weights and activation. The accuracy trend with bit-width of weights and activations is shown, as well as the trend for number of bit-flips required to complete malfunction. One objective of this disclosure is to simultaneously improve robustness and clean accuracy. In line with prior defense works, an increase in network robustness with a lower bit-width network is observed, especially for the case of binary neural network (BNN, 1 bit) with significant improvement. Besides, BNN comes with additional computation and memory benefits which makes it a great candidate for mobile and hardware-constrained applications.

As a result of this trend, many prior works investigated different ways of training a complete BNN. However, a general conclusion among them is that BNN suffers from heavy inference accuracy loss. A similar trend is observed in FIG. 1 where decreasing the bit-width of a given model negatively impacts the inference accuracy. This presents a challenging optimization problem where a lower bit-width network comes with improved robustness but at the cost of lower accuracy. One objective of this disclosure is to develop a BNN to improve its robustness (i.e., resistance to BFA attack), while not sacrificing the clean accuracy.

To achieve this, a robust and accurate binary neural network (RA-BNN) is disclosed, which provides a novel defense scheme against BFA. The defense scheme includes two key components. First, advantage is taken of the BNN's capability in providing improved resistance against bit-flip attack through completely binarizing both activations and weights of every DNN layer. Second, to address the clean model accuracy loss, a novel BNN network growing method, early growth, is introduced. Early growth selectively grows the output channels of every BNN layer to recover accuracy loss. Moreover, apart from recovering accuracy, increasing the channel size can also help to resist BFA attack.

Embodiments described herein provide several technical contributions. First, the proposed RA-BNN, utilizing BNN's intrinsic robustness improvement against BFA attack, binarizes both weight and activation of the DNN model. Unlike most prior BNN related works, the weights of every layer are binarized, including the first and last layer. This is referred to herein as complete BNN. In addition, all activations except the input going into the first (i.e., input image) and last layer (i.e., final classification layer) are binarized.

Second, to compensate clean model accuracy loss of a complete BNN model, early growth provides a trainable mask-based growing method to gradually and selectively grow the output channels of BNN layers. Since the network growing inevitably requires large computing complexity, to improve training efficiency early growth follows a two-stage training mechanism with an early stop mechanism of network growth. The first stage is to jointly train binary weights and channel-wise masks through Gumbel-Sigmoid function at the early iterations of training. As the growth of binary channels converges, it goes to the second stage, where the channel growing is stopped and only the binary weights will be trained based on the network structure trained in the first stage to further minimize accuracy loss.

Finally, extensive evaluations are performed on CIFAR-10, CIFAR-100 and ImageNet datasets on popular DNN architectures (e.g., ResNets, VGG). Evaluation on the CIFAR-10 dataset shows that the proposed RA-BNN can improve the clean accuracy by ˜2-8% of a complete BNN while improving the resistance to BFA by more than 125×. On the ImageNet dataset, RA-BNN gains 9% clean model accuracy compared to state-of-the-art baseline BNN model while completely defending against BFA (i.e., 5,000 bit-flips only degrade the accuracy to around 37%). In comparison, the baseline BNN accuracy degrades to 4.3% with 5,000 bit-flips.

### II. Defense Intuition

A key defense intuition of the proposed RA-BNN is inspired by the BNN's intrinsic improved robustness against adversarial weight noise. The resistance of binarized weights to BFA is a well-investigated phenomenon. The evaluation presented in Table 1 also demonstrates the efficacy of a binary weight model in comparison to an 8-bit quantized weight model. However, unlike prior works, embodiments described herein completely binarize DNN model including both weights and activations. Surprisingly, Table 1 shows that a complete BNN requires ˜39× more bit-flips than an 8-bit model to achieve the same attack objective (i.e., 10% accuracy).

Observation 1: A complete binary neural network (i.e., both binary weights and activations) improves the robustness of a DNN significantly (e.g., ˜39× in the example of Table 1).

TABLE 1
Resnet-20 performance on CIFAR-10 dataset

| | Clean | Acc. After | # of |
|---|---|---|---|
| Model Type | Acc. (%) | Attack (%) | Bit-Flips |
| 8-bit weight | 92.7 | 10.0 | 28 |
| Binary weight | 89.01 | 10.99 | 89 |
| Binary weight + | 82.33 | 10.0 | 1080 |
| activation | | | |

As shown in Table 1, while the complete BNN may provide superior robustness, it comes at the cost of reducing the test accuracy by 10.0% (from 92.7% to 82.33%) even on a small dataset with 10 classes. FIG. 1 demonstrates the trend of decreasing network bit-width can improve DNN robustness at the expense of accuracy loss.

FIG. 2 is a graphical representation of clean accuracy of three binary models with channel multiplier varied as 1/2/3 and an 8-bit model. Here, channel multiplier means the output and input channel of each layer is multiplied by a constant (i.e., 1, 2, or 3). As the channel multiplier increases from 1 to 3, it is possible to recover the accuracy of a complete BNN model close to the 8-bit precision model.

Observation 2: By multiplying the input and output channel width with a large factor (e.g., 3), BNN accuracy degradation is largely compensated.

Inspired by observations 1 and 2, embodiments described herein aim to resolve the accuracy and robustness trade-off presented in FIG. 1 by constructing a DNN with complete binarization in computation level and fined-grained channel multiplication at architecture level. However, the technical challenges come from how to learn the channel multiplier (e.g., 2×, 2.5×, 3×, etc.) before training. Besides, it is also important to minimize the model size increment through optimizing layer-wise fine-grained multipliers, instead of uniform channel multiplier across whole layers. Therefore, an objective of this disclosure is to develop a general methodology to recover BNN accuracy with a fine-grained channel multiplier for each layer with little additional cost.

To achieve this, embodiments provide a channel width optimization technique called early growth, which is a general method of growing a given complete BNN model at early training iterations by selectively and gradually growing certain channels of each layer.

In summary, the defense intuition is to leverage binary weights and activations to improve the robustness of DNN, while growing channel size of each individual BNN layer using the proposed early growth method to simultaneously recover the accuracy loss and further boost the robustness. Early growth ensures two key advantages of interest: i) the constructed RA-BNN does not suffer from heavy clean model accuracy loss, and ii) it supplements the intrinsic robustness improvement through marginally increasing BNN channel size.

### III. Proposed RA-BNN

The proposed RA-BNN includes two aspects to improve robustness and accuracy simultaneously. First, the weights of every DNN layer are binarized, including the first and last layers. Further, to improve the robustness, the inputs going into each layer are also binarized, except the first and last one. Such a complete BNN with binary weights and activation is a principal component of the defense mechanism. Second, to recover the accuracy and further improve the robustness of a complete BNN model, early growth is proposed as a fast and efficient way of growing a BNN with a trainable channel width of each individual layer.

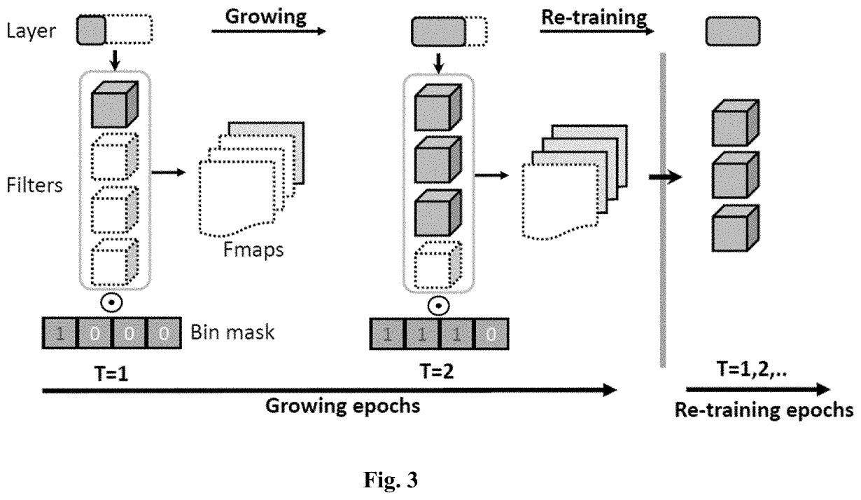

FIG. 3 is a schematic diagram illustrating the early growth method according to embodiments described herein. Early growth uses a two-stage training. In stage-1 (growing stage), the model grows gradually and selectively from the initial baseline model to a larger model in a channel-wise manner. It is achieved by learning binary masks associated with each weight channel (growing when switching from ‘0’ to ‘1’ at the first time), to enable training-time growth. As the network growth becomes stable after a few initial iterations, the growth will stop and enter stage-2. In stage-2, the new model obtained in stage-1 will be re-trained to minimize the defined loss. After completing both the growing and re-training stages, a complete BNN with improved robustness is obtained without sacrificing large inference accuracy loss.

Although some prior approaches also utilize mask-based learning to grow DNN models, there are two key differences to highlight here: 1) such past approaches jointly train the mask and weight for the whole training process, which is unstable and suffers from higher training cost. Embodiments of RA-BNN instead adopt a two-step training scheme with an early stop of growing, improving the training efficiency and thus scalability. 2) More importantly, the prior approaches generate the binary mask by learning full precision mask following non-differential Bernoulli sampling, which leads to a multiplication between full precision weight and full precision mask in the forward pass. This method is not efficient in BNN training with binary weight, where it is much preferred to only use binary-multiplication with both operands (i.e., weight and mask) in binary format. To achieve this goal, a differentiable Gumbel-Sigmoid method is proposed, as will be discussed below, to learn binary mask and guarantee binary-multiplication between weight and mask in the forward path.

### A. Binarization

The first step is to construct a complete BNN with binary weights and activations. Training a neural network with binary weights and activations presents the challenge of approximating the gradient of a non-linear sign function. To compute the gradient efficiently and improve the binarization performance, embodiments use a training aware binary approximation function instead of the direct sign function:

$$f ( z ) = \{ \begin{matrix}k \cdot ( - sign ( z ) \frac{{t}^{2} {z}^{2}}{2} + \sqrt{2} z ) , & if z < \frac{\sqrt{2}}{r} \\ k \cdot sign ( z ) , & otherwise\end{matrix} \begin{matrix} \\ \end{matrix} \qquad Equation 1$$

$$t = 1 {0}^{- 2 + \frac{3 i}{T}} ; k = max ( \frac{1}{t} , 1 ) \qquad Equation 2$$

where i is the current training iteration and T is the total number of iterations.

At the early training stage, i/T is low, and the above function is continuous. As the training progresses, the function gradually becomes a sign function whose gradient can be computed as:

$${f}^{′ ( z )} = \frac{δ f ( z )}{δ z} = max ( k \cdot \sqrt{2} t - \vert {t}^{2} z \vert , 0 ) \qquad Equation 3$$

For weight binarization, z represents full-precision weights (z=w_{ƒp}), and for activation binarization, z represents full-precision activation input going into the next convolution layer (z=α_{ƒp}). The RA-BNN binarizes the weights of every layer including the first and last layers. However, for activation, RA-BNN binarizes every input going into the convolution layer except the first layer input.

### B. Early Growth

The goal of the proposed early growth method is to grow each layer's channel-width of a given BNN model during training to help recover the inference accuracy and further improve the robustness. As shown in FIG. 3, early growth includes two training stages: stage-1 (growing) and stage-2 (re-training). The objective of the growing stage is to learn to grow the output channel size of each layer during the initial iterations of training. As the network architecture becomes stable, the growing stage will stop and generate a new model architecture for stage-2 to re-train the weight parameters.

### 1. Stage-1: Growing

In order to gradually grow the network by increasing the output channel size, the channel-wise binary mask is utilized as an indicator (e.g., on/off). Considering a convolution layer with input channel size cᵢₙ, output channel size cₒᵤₜ, filter size k×k and output filter w^{j} ∈ R^{{k×k×c}ₒᵤₜ}; then the j^{th} (j ∈1, 2, . . . cₒᵤₜ) output feature from a convolution operation becomes:

hₒᵤₜ^{j}=conv(hᵢₙ, w_{b}^{j}⊙m_{b}^{j}) Equation 4

where w_{b}^{j} ⊙ [−1,1] is a binary weight (w_{b}^{j}=ƒ(w_{ƒp}^{j})), and m_{b}^{j} ⊙ [0,1] is a binary mask.

When the binary mask is set to 0, the entire j^{th} output filter is detached from the model. As both weight and mask are in binary format, such element-wise multiplication can be efficiently computed using a binary multiplication operation (e.g., XNOR), instead of floating-point multiplication. This is the reason to guarantee both the weight and mask are in binary format in the forward path. The growing stage starts from a given baseline model (e.g., ×1 channel width) and each channel is associated with a trainable mask. During training, a new output filter channel will be created (i.e., growing) when the mask switches from 0 to 1 for the first time. An example of this growing procedure is illustrated in FIG. 3. The growing stage optimization objective can be mathematically formalized as:

$${min}_{{w}_{b} , {m}_{b}} {ℒ}_{E} ( g ( {w}_{b} ⊙ {m}_{b} ; {x}_{t} ) , {y}_{t} ) \qquad Equation 5$$

where g(.) is the complete BNN inference function. However, the discrete states (i.e., non-differential) of the binary masks m_{b} make their optimization using gradient descent a challenging problem.

### 2. Training Binary Mask

The conventional way of generating the binary trainable mask is to train a learnable real-valued mask (m_{ƒp}) followed by a hard threshold function (e.g., sign function) to binarize it. However, such a hard threshold function is not differentiable, the general solution is to approximate the gradients by skipping the threshold function during back-propagation and update the real-value masks directly.

This disclosure instead proposes a method to eliminate the gradient estimation step and make whole mask learning procedure differentiable, and thus compatible with the existing gradient-based back-propagation training process. First, the hard threshold function is relaxed to a continuous logistic function:

$$σ ( {m}_{fp} ) = \frac{1}{1 + exp ( - β {m}_{fp} )} \qquad Equation 6$$

where β is a constant scaling factor. Note that the logistic function becomes closer to the hard thresholding function for higher β values.

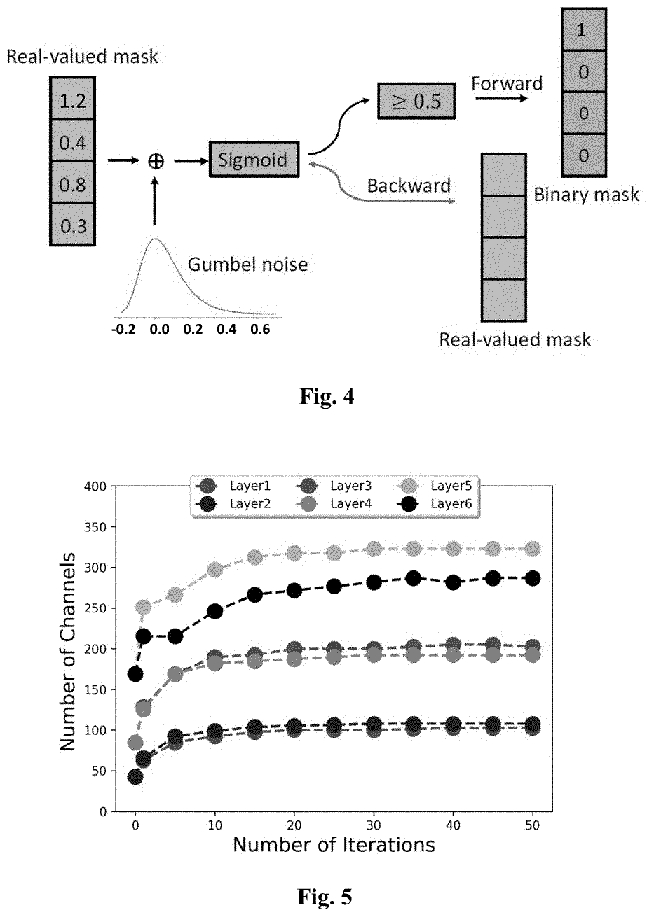

FIG. 4 is a schematic diagram illustrating binary mask training according to embodiments described herein through a combination of Gumbel-Sigmoid function and hard thresholding. To learn the binary mask, embodiments leverage the Gumbel-Sigmoid trick, which performs a differential sampling to approximate a categorical random variable. Since sigmoid can be viewed as a special two-class case of softmax, p(.) is defined using the Gumbel-Sigmoid trick as:

$$p ( {m}_{fp} ) = \frac{exp ( ( log {π}_{0} + {g}_{0} ) / T )}{exp ( ( log {π}_{0} + {g}_{0} ) / T ) + exp ( ( {g}_{1} ) / T )} \qquad Equation 7$$

where π₀ represents σ(m_{ƒp}). g₀ and g₁ are samples from Gumbel distribution. The temperature T is a hyper-parameter to adjust the range of input values, where choosing a larger value could avoid gradient vanishing during back-propagation. Note that the output of p(m_{ƒp}) becomes closer to a Bernoulli sample as T is closer to 0. Equation 7 can be further simplified as:

$$p ( {m}_{fp} ) = \frac{1}{1 + exp ( - ( log {π}_{0} + {g}_{0} - {g}_{1} ) / T )} \qquad Equation 8$$

Benefiting from the differentiable property of Equation 6 and Equation 8, the real-value mask m_{ƒp} can be embedded with existing gradient based back-propagation training without gradient approximation. During training, most values in the distribution of p(m_{ƒp}) will move towards either 0 or 1. To represent p(m_{ƒp}) as binary format, a hard threshold (e.g., 0.5) is used during forward-propagation of training, which has no influence on the real-value mask to be updated for back-propagation as shown in FIG. 4. Finally, the optimization objective in Equation 5 can be reformulated as:

$${min}_{{w}_{fp} , {m}_{fp}} {ℒ}_{E} ( g ( f ( {w}_{fp} ) ⊙ p ( {m}_{fp} ) ; {x}_{t} ) , {y}_{t} ) \qquad Equation 9$$

### 3. Stage-2: Re-training

After stage-1, the grown BNN structure (i.e., channel index for each layer) is obtained, which is indicated by the channel-wise mask m_{b}. Then, in stage-2, the new BNN model w_{ƒp}* is constructed using the weight channels with mask values as 1 in m_{b} and the rest is discarded. In stage-2 training, the newly constructed BNN's weight parameters will be trained without involving any masks. The re-training optimization objective can be formulated as:

$${min}_{{w}_{fp}^{*}} {ℒ}_{E} ( g ( f ( {w}_{fp}^{*} ) ; {x}_{t} ) , {y}_{t} ) \qquad Equation 10$$

After completing the re-training stage, a complete BNN is obtained with simultaneously improved robustness and clean model accuracy.

### IV. Evaluation Details

### A. Dataset and Architecture

RA-BNN is evaluated on three popular vision datasets: CIFAR-10, CIFAR-100, and ImageNet (as described in Alex Krizhevsky, Ilya Sutskever, and Geoffrey E Hinton, “ImageNet Classification with Deep Convolutional Neural Networks,” in Advances in Neural Information Processing Systems, pages 1097-1105, 2012). In the evaluation, the dataset is split following the standard practice of splitting it into training and test data 1. ResNet-20, ResNet-18, and a small VGG architecture (as described in Mingbao Lin, Rongrong Ji, Zihan Xu, Baochang Zhang, Yan Wang, Yongjian Wu, Feiyue Huang, and Chia-Wen Lin, “Rotated Binary Neural Network,” in Advances in Neural Information Processing Systems 33 (NeurIPS), 2020, referred to herein as “RBNN”) are trained for CIFAR-10 dataset. For both CIFAR-100 and ImageNet, the efficacy of the method is demonstrated in ResNet-18.

The same DNN architecture, training configuration, and hyper-parameters as RBNN are followed. The same weight binarization method as RBNN is also followed, including applying the rotation on the weight tensors before binarization.

### B. Attack and Defense Hyper-Parameters

Un-targeted BFA degrades the DNN accuracy close to a random guess level (1/no. of class)×100 (e.g., 10% for CIFAR-10, 1% for CIFAR-100, and 0.1% for ImageNet). N-to-1 targeted attack is also performed where the attacker classifies all the inputs into a specific target class, which again will degrade the overall test accuracy to a random guess level. The attack three rounds are run and the best round is reported in terms of the number of bit-flips required to achieve the desired objective. The maximum number of bits the attacker can flip is assumed to be 5,000, based on practical prior experiments. To get around strong bit-flip protection schemes requires around 95 hours to flip 91 bits using double-sided row-hammer attack. At this rate, to flip 5,000 bits, it would take around seven months, which is practically impossible. Thus, if the defense can resist 5,000 bit-flips, it can safely be claimed that RA-BNN can completely defend against BFA.

### 1. Defense Hyper-Parameters

The first step of the training phase is to perform growing. To do so, it is necessary to initialize the mask values. The mask values of the base model (×1) are initialized to be equal to 1. Thus, the base architecture channels always remain attached to the model at the beginning of the training. Next, the rest of the masks are initialized with a negative value within the range of −1 to −0.1 to keep their corresponding binary mask value (m_{b}) equal to 0 initially.

After growing, the model is generally re-initialized keeping only the channels with mask values equal to 1 and discarding the rest of the channels for VGG, AlexNet or other architectures without residual connection. However, in particular for residual models (e.g., ResNet-18), each layer within the basic-block is ensured to have the same size (i.e., equal to the size of the layer with maximum channel size) to avoid output size mismatch between the residual connections and next layer. Next, the β values are also initialized by setting them equal to 1. Besides at each iteration of the growing stage, the beta values are updated using a beta scheduler.

### C. Evaluation Metric

Clean Accuracy % (CA) is the percentage of test samples correctly classified by the DNN model when there is no attack.

Post-Attack Accuracy % (PA) is defined as the test accuracy after conducting the BFA attack on the DNN model.

To measure the model robustness, the number of bit-flips required to degrade the DNN accuracy to a random guess level (e.g., 10.0% for CIFAR-10) is reported.

To evaluate the DNN model size, the total number of weight bits (B) present in the model is reported in millions.

### V. Results

### A. Accuracy Evaluation

The performance of the proposed RA-BNN method in recovering the accuracy of a BNN is presented in Table 2. First, for CIFAR-10, the clean accuracy drops by 3.6% after binarization. However, by growing the model by 2× from a base (1×) BNN model, the proposed early growth helps to recover the clean accuracy back to 92.9%. Similarly, for CIFAR-100 and ImageNet, the clean accuracy drops by ˜9% and ˜18% after weight and activation binarization of every layer for ResNet-18. Again, after growing the base (1×) BNN model to a 6.5× size, early growth recovers ˜9% of the clean accuracy on ImageNet.

TABLE 2
Clean accuracy and number of weight-bits of
ResNet-18 model on three datasets

| | CIFAR-10 | | | | CIFAR-100 | | | | ImageNet | | | |
|---|---|---|---|---|---|---|---|---|---|---|---|---|
| Model | Weight- | | Clean | | Weight- | | Clean | | Weight- | | Clean | |
| Type | Bits (M) | | Acc. (%) | | Bits (M) | | Acc. (%) | | Bits (M) | | Acc. (%) | |
| Full- | 357.8 | (32×) | 94.2 | | 362.2 | (32×) | 76.2 | | 374.4 | (32×) | 69.7 | |
| Precision | | | | | | | | | | | | |
| Binary | 11.18 | | 90.14 | | 11.32 | | 66.14 | | 11.7 | | 51.9 | |
| (RBNN) | | | | | | | | | | | | |
| RA-BNN | 23.37 | (~2×) | 92.9 | (~3↑) | 39.53 | (~4×) | 72.29 | (~6↑) | 73.09 | (~6.5×) | 60.9 | (~3↑) |

In summary, complete binarization impacts the clean accuracy of BNN by up to 18% degradation on a large-scale dataset (e.g., ImageNet). Thus, recovering the accuracy near the baseline full-precision model becomes extremely challenging. Moreover, unlike prior BNNs that do not binarize the first and last layers, embodiments described herein binarize every layer and achieve 60.9% clean accuracy. The next subsection demonstrates that the RA-BNN's under-attack accuracy still holds to 37% while all the other baseline models drop below 5% (see Table 4).

### B. Robustness Evaluation

### 1. CIFAR-10

Table 3 summarizes the robustness analysis on CIFAR-10 dataset. First, for un-targeted attack, the proposed RA-BNN improves the resistance to BFA by requiring 125× more bit-flips for ResNet-20. As for ResNet-18 and VGG, they demonstrate even higher resistance to BFA. The attack fails to degrade the accuracy below 72% even after 5,000 flips on VGG architecture. Similarly, the attack fails to break the defense on ResNet-18 architecture as well. Even after 5,000 flips the test accuracy still holds at 51.29%, while it requires only 17-30 flips to completely malfunction the baseline models (e.g., 4-bit/8-bit). In conclusion, the proposed RA-BNN increases the model's robustness to BFA significantly, most notably completely defending BFA on the VGG model.

TABLE 3
Summary of Robustness Analysis of CIFAR-10

| | | | | | | | | | | | | |
|---|---|---|---|---|---|---|---|---|---|---|---|---|
| Model | Total | | | | Total | | | # of | Total | | | # of |
| Bit | Weight | CA | PA | # of Bit | Weight | TA | PA | Bit | Weight | CA | PA | Bit |
| Width | Bits (M) | (%) | (%) | Flips | Bits (M) | (%) | (%) | Flips | Bits (M) | (%) | (%) | Flips |

| | | |
|---|---|---|
| ResNet-20 | ResNet-18 | VGG |

Un-Targeted Attack: The classification accuracy drops down to random guess level
(e.g., for a 10 class problem: 1/10 × 100 = 10%)

| | | | | | | | | | | | | |
|---|---|---|---|---|---|---|---|---|---|---|---|---|
| 8-bit | 2.16 | 91.71 | 10.9 | 20 | 89.44 | 93.74 | 10.01 | 17 | 37.38 | 93.47 | 10.8 | 34 |
| 4-bit | 1.08 | 90.27 | 10.1 | 25 | 44.72 | 93.13 | 10.87 | 30 | 18.64 | 90.76 | 10.93 | 26 |
| Binary | 0.27 | 82.33 | 10.0 | 1080 | 11.18 | 90.14 | 17.7 | 5000 | 4.66 | 89.24 | 10.99 | 2149 |
| RA- | 1.94 | 90.18 | 10.0 | 2519 | 23.37 | 92.9 | 51.29 | 5000 | 20.6 | 91.58 | 72.68 | 5000 |
| BNN | | | | (×125) | | | | (×294) | | | | (×147) |

Targeted Attack: Classifies all the inputs to a target class. As a result, for a 10 class problem test accuracy drops to 10.0%

| | | | | | | | | | | | | |
|---|---|---|---|---|---|---|---|---|---|---|---|---|
| 8-bit | 2.16 | 91.71 | 10.51 | 6 | 89.44 | 93.74 | 10.71 | 20 | 37.38 | 93.47 | 10.75 | 28 |
| 4-bit | 1.08 | 90.27 | 10.72 | 4 | 44.72 | 93.13 | 10.21 | 21 | 18.64 | 90.76 | 10.53 | 13 |
| Binary | 0.27 | 82.33 | 10.99 | 529 | 11.18 | 90.14 | 10.99 | 1545 | 4.66 | 89.24 | 10.99 | 2157 |
| RA- | 1.94 | 90.18 | 10.97 | 226 | 23.37 | 92.9 | 10.99 | 3983 | 20.6 | 91.58 | 78.99 | 5000 |
| BNN | | | | (×37.66) | | | | (×199) | | | | (×178) |

However, the targeted BFA is more effective against the RA-BNN. As Table 3 shows, RA-BNN still improves the resistance to BFA by 37× and 199× on ResNet-20 and ResNet-18 architectures, respectively, in comparison to 8-bit model counterparts. For the VGG model, the targeted BFA can only degrade the DNN accuracy to 78.99% even after 5,000 bit-flips; thus completely defending the attack. In summary, BFA can degrade the DNN accuracy to near-random guess level (i.e., 10%) with only ˜4-34 bit-flips. But RA-BNN improves the resistance to BFA significantly. Even after 37-294× more bit-flips, it still fails to achieve the desired attack goal.

### 2. CIFAR-100 and ImageNet

The proposed RA-BNN improves the resistance to BFA on large-scale datasets (e.g., CIFAR-100 and ImageNet) as well. As presented in Table 4, the baseline 8-bit models require less than 25 bit-flips to degrade the interference accuracy close to a random guess level. While binary model improves the resistance to BFA, it is still possible to significantly reduce (e.g., 4.3%) the inference accuracy with a sufficiently large (e.g., 5,000) amount of bit-flips. But the proposed RA-BNN outperforms both 8-bit and binary baseline, as even after 5,000 bit-flips the accuracy only degrades to 37.1% on ImageNet.

TABLE 4
Robustness evaluation of CIFAR-100
and ImageNet against BFA

| | CIFAR-100 | | | ImageNet | | |
|---|---|---|---|---|---|---|
| | CA | PA | # of Bit- | CA | PA | # of Bit- |
| | (%) | (%) | Flips | (%) | (%) | Flips |
| Baseline | 75.19 | 1.0 | 23 | 69.1 | 0.11 | 13 |
| Binary | 66.14 | 15.47 | 5000 | 51.9 | 4.33 | 5000 |
| RA-BNN | 72.29 | 54.22 | 5000 | 60.9 | 37.1 | 5000 |

### C. Comparison to Competing Method

The RA-BNN defense performance in comparison to other SOTA BNN is summarized in Table 5. An impressive 62.9% Top-1 clean accuracy on ImageNet is achieved, beating all the prior BNN works by a fair margin. However, this improvement in clean accuracy comes at the cost of additional model size overhead (e.g., memory) which will be discussed in Section 5.D.

TABLE 5
State-of-the-art binary ResNet-18 models on ImageNet
(Top-1 and Top-5 Clean Accuracy (%))

| Method | Top-1 | Top-5 | Method | Top-1 | Top-5 |
|---|---|---|---|---|---|
| ABC-Net | 42.7 | 67.6 | XNOR++ | 57.1 | 79.9 |
| XNOR-Net | 51.2 | 73.2 | IR-Net | 58.1 | 80 |
| BNN+ | 53.0 | 72.6 | RBNN | 59.9 | 81.9 |
| Bi-Real | 56.4 | 79.5 | RA-BNN | 62.9 | 84.1 |

Apart from accuracy gain, the RA-BNN's major goal is to improve the robustness to BFA. The superior defense performance is summarized in Table 6, where RA-BNN again outperforms all existing defenses. Even in comparison to the best existing defense binary weight model, BFA requires 28× more bit-flips to break the defense.

TABLE 6
Comparison to other competing defense
methods on CIFAR-10 dataset
evaluated attacking a ResNet-20 model

| Models | CA (%) | PA (%) | # of Bit-Flips |
|---|---|---|---|
| Baseline ResNet-20 | 91.71 | 10.9 | 20 |
| Piece-wise Clustering | 90.02 | 10.09 | 42 |
| Binary Weight | 89.01 | 10.99 | 89 |
| Model Capacity × 16 | 93.7 | 10.0 | 49 |
| Weight Reconstruction | 88.79 | 10.0 | 79 |
| RA-BNN | 90.18 | 10.0 | 2519 |

### D. Defense Overhead

From the evaluation results presented above (e.g., Table 3), it is evident that the accuracy and robustness improvement of RA-BNN comes at the expense of larger model size. But even after growing the binary model size, RA-BNN remains within 26-90% of the size of an 8-bit model, while achieving more than 125× improvement in robustness. To give an example, the RA-BNN model size increases by 4× in comparison to a baseline binary model for VGG. Still, the RA-BNN can achieve similar accuracy as a 4-bit model with comparable model size (Table 3). However, FIG. 1 already demonstrated that a 4-bit quantized model fails to defend against BFA.

Similarly, the RA-BNN ResNet-18 model size is 2× (same size as 2-bit) than a binary baseline model. Again, the accuracy of this model is comparable to a 4-bit model as shown in Table 3. Thus, in conclusion, the proposed RA-BNN model stays within the memory budget of a 2- to 6-bit model while improving the resistance to BFA by more than 125× with significantly higher (2-9%) clean accuracy than a binary model.

### E. Early Growth Training Evolution

FIG. 5 is a graphical representation of a sample training of RA-BNN where early growth increases the number of activating channels at each layer of a BNN. As the training iteration increases most of the layer channel reaches a saturation point. At around iteration number 35, most of the layer channel size becomes stable, and the growing step is terminated. At this stage, the model is re-initialized for the re-training step. In the evaluation, the growing step is terminated when most layer channel size remained fixed for two successive iterations.

### F. Layer-Wise Bit-Flip Analysis

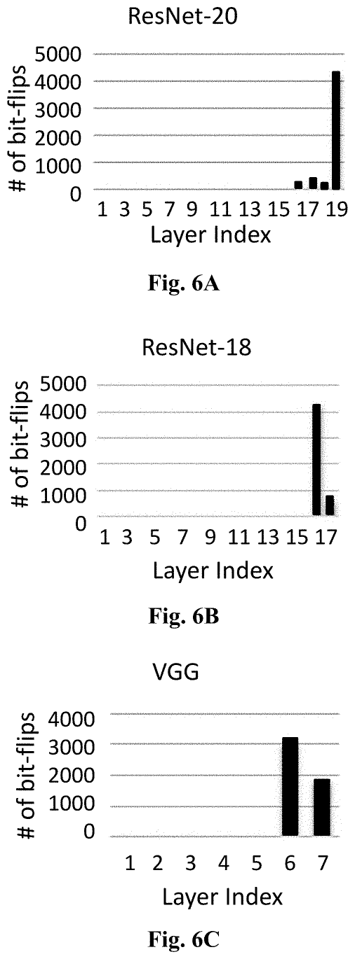

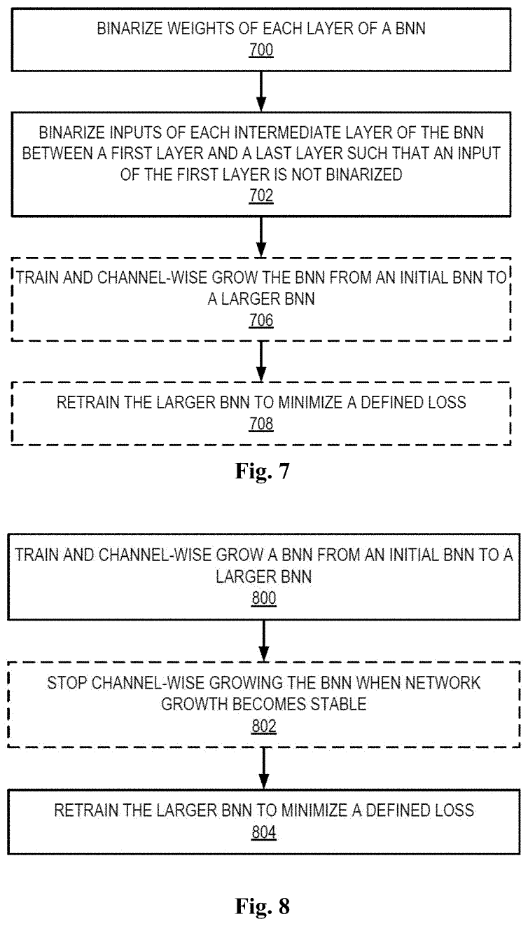

FIG. 6A is a graphical representation of a layer-wise bit-flip profile of RA-BNN evaluated on ResNet-20. FIG. 6B is a graphical representation of a layer-wise bit-flip profile of RA-BNN evaluated on ResNet-18. FIG. 6C is a graphical representation of a layer-wise bit-flip profile of RA-BNN evaluated on VGG.

Previous BFA defense works have demonstrated that the majority of the bit-flips occur in the first and last layer of a DNN. However, after binarization, it is observed that most of the bit-flips exist in the last two layers. The reason being RA-BNN binarizes every layer weight and activation except the input activation going into the last layer. Otherwise, all the other layer input is constrained within binary values. As a result, the input going into the last layer contains floating-point values, which is the only vulnerable point to cause significant error in the final classification layer computation by injecting faults into the last two layers. Thus, binarizing the input going into the last layer can nullify BFA attacks even further.

### VI. Methods for Strengthening and Training BNNs

FIG. 7 is a flow diagram illustrating a process for strengthening a BNN against adversarial noise injection. Dashed boxes represent optional steps. The process begins at operation 700, with binarizing weights of each layer of a BNN. The process continues at operation 702, with binarizing inputs of each intermediate layer of the BNN between a first layer and a last layer such that an input of the first layer is not binarized. In an exemplary aspect, operations 700 and 702 produce a complete BNN having binary weights and activation, which protects against adversarial noise injection. In some embodiments, the inputs of both the first layer and the last layer are not binarized.

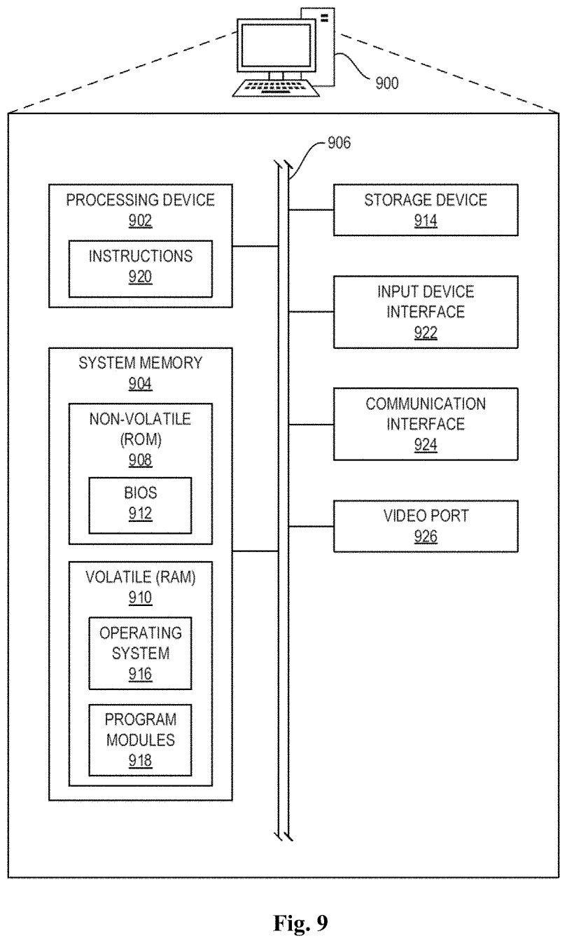

The process optionally continues at operation 704, with training and channel-wise growing the BNN from an initial BNN to a larger BNN. The process optionally continues at operation 706, with retraining the larger BNN to minimize a defined loss. Operations 704 and 706 may comprise an early growth approach to training the BNN and may further include steps and operations described above and in FIG. 8.

FIG. 8 is a flow diagram illustrating a process for training a BNN using early growth. Dashed boxes represent optional steps. The process begins at operation 800, with training and channel-wise growing a BNN from an initial BNN to a larger BNN. In an exemplary aspect, operation 800 includes learning binary masks associated with each weight channel. The process may optionally continue at operation 802, with stopping channel-wise growing the BNN when network growth becomes stable. This may occur after a few iterations of growth, as described above. The process continues at operation 804, with retraining the larger BNN to minimize a defined loss.

Although the operations of FIGS. 7 and 8 are illustrated in a series, this is for illustrative purposes and the operations are not necessarily order dependent. Some operations may be performed in a different order than that presented. Further, processes within the scope of this disclosure may include fewer or more steps than those illustrated in FIGS. 7 and 8.

### VII. Computer System

FIG. 9 is a block diagram of a computer system 900 suitable for implementing the RA-BNN according to embodiments disclosed herein. The computer system 900 comprises any computing or electronic device capable of including firmware, hardware, and/or executing software instructions that could be used to perform any of the methods or functions described above, such as strengthening a BNN against adversarial noise injection and/or training a binary BNN using early growth. In this regard, the computer system 900 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

The exemplary computer system 900 in this embodiment includes a processing device 902 or processor, a system memory 904, and a system bus 906. The system memory 904 may include non-volatile memory 908 and volatile memory 910. The non-volatile memory 908 may include read-only memory (ROM), erasable programmable read-only memory (EPROM), electrically erasable programmable read-only memory (EEPROM), and the like. The volatile memory 910 generally includes random-access memory (RAM) (e.g., dynamic random-access memory (DRAM), such as synchronous DRAM (SDRAM)). A basic input/output system (BIOS) 912 may be stored in the non-volatile memory 908 and can include the basic routines that help to transfer information between elements within the computer system 900.

The system bus 906 provides an interface for system components including, but not limited to, the system memory 904 and the processing device 902. The system bus 906 may be any of several types of bus structures that may further interconnect to a memory bus (with or without a memory controller), a peripheral bus, and/or a local bus using any of a variety of commercially available bus architectures.

The processing device 902 represents one or more commercially available or proprietary general-purpose processing devices, such as a microprocessor, central processing unit (CPU), or the like. More particularly, the processing device 902 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 902 is configured to execute processing logic instructions for performing the operations and steps discussed herein.

In this regard, the various illustrative logical blocks, modules, and circuits described in connection with the embodiments disclosed herein may be implemented or performed with the processing device 902, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 902 may be a microprocessor, or may be any conventional processor, controller, microcontroller, or state machine. The processing device 902 may also be implemented as a combination of computing devices (e.g., a combination of a DSP and a microprocessor, a plurality of microprocessors, one or more microprocessors in conjunction with a DSP core, or any other such configuration).

The computer system 900 may further include or be coupled to a non-transitory computer-readable storage medium, such as a storage device 914, which may represent an internal or external hard disk drive (HDD), flash memory, or the like. The storage device 914 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 916 and any number of program modules 918 or other applications can be stored in the volatile memory 910, wherein the program modules 918 represent a wide array of computer-executable instructions corresponding to programs, applications, functions, and the like that may implement the functionality described herein in whole or in part, such as through instructions 920 on the processing device 902. The program modules 918 may also reside on the storage mechanism provided by the storage device 914. As such, all or a portion of the functionality described herein may be implemented as a computer program product stored on a transitory or non-transitory computer-usable or computer-readable storage medium, such as the storage device 914, volatile memory 910, non-volatile memory 908, instructions 920, and the like. The computer program product includes complex programming instructions, such as complex computer-readable program code, to cause the processing device 902 to carry out the steps necessary to implement the functions described herein.

An operator, such as the user, may also be able to enter one or more configuration commands to the computer system 900 through a keyboard, a pointing device such as a mouse, or a touch-sensitive surface, such as the display device, via an input device interface 922 or remotely through a web interface, terminal program, or the like via a communication interface 924. The communication interface 924 may be wired or wireless and facilitate communications with any number of devices via a communications network in a direct or indirect fashion. An output device, such as a display device, can be coupled to the system bus 906 and driven by a video port 926. Additional inputs and outputs to the computer system 900 may be provided through the system bus 906 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A robust and accurate binary neural network (RA-BNN), comprising:
a first deep neural network (DNN) layer having a non-binary input and binarized weights;
a last DNN layer having a non-binary input and binarized weights; and
one or more intermediate DNN layers between the first DNN layer and the last DNN layer, wherein the one or more intermediate DNN layers have binary inputs and binarized weights.

2. The RA-BNN of claim 1, wherein the last DNN layer has a non-binary input.

3. The RA-BNN of claim 1, wherein the RA-BNN is trained using early growth.

4. The RA-BNN of claim 3, wherein the early growth comprises:
training and channel-wise growing the RA-BNN from an initial RA-BNN to a larger RA-BNN; and
retraining the larger RA-BNN to minimize a defined loss.

5. The RA-BNN of claim 3, wherein the early growth comprises: at least one learning binary mask associated with at least one weight channel.

6. The RA-BNN of claim 3, wherein the early growth starts from a given baseline model and each channel is associated with a trainable mask.

7. The RA-BNN of claim 6, wherein an output filter channel is created when the mask switches from 0 to 1 for the first time.

8. The RA-BNN of claim 1, wherein the RA-BNN is trained using a differentiable Gumbel-Sigmoid method.

9. The RA-BNN of claim 1, wherein the RA-BNN resides on a computing system.

10. The RA-BNN of claim 1, further comprising a channel index for each layer.

11. A method for strengthening a binary neural network (BNN) against adversarial noise injection, the method comprising:
binarizing weights of each layer of the BNN; and
binarizing inputs of each intermediate layer of the BNN between a first layer and a last layer such that an input of the first layer is not binarized.

12. The method of claim 11, wherein an input of the last layer is not binarized.

13. The method of claim 11, further comprising training and channel-wise growing the BNN from an initial BNN to a larger BNN.

14. The method of claim 13, further comprising retraining the larger BNN to minimize a defined loss.

15. The method of claim 13, further comprising stopping channel-wise growing the BNN when network growth becomes stable.

16. A method for training a binary neural network (BNN) using early growth, the method comprising:
training and channel-wise growing the BNN from an initial BNN to a larger BNN; and
retraining the larger BNN to minimize a defined loss.

17. The method of claim 16, wherein training and channel-wise growing the BNN from the initial BNN to the larger BNN comprises learning binary masks associated with each weight channel.

18. The method of claim 17, further comprising, when network growth becomes stable:
stopping channel-wise growing the BNN; and
starting retraining the larger BNN to minimize the defined loss.

19. The method of claim 16, further comprising binarizing weights of each layer of the BNN.

20. The method of claim 19, further comprising binarizing inputs of each intermediate layer of the BNN between a first layer and a last layer such that an input of the first layer is not binarized.
